(19) United States
(12) Patent Application Publication
(10) Pub. No.: US 2013/0033052 A1
(43) Pub. Date: Feb. 7, 2013

(54) TOOL FOR REMOVAL OF VINES AND OTHER VEGETATION FROM HOT POWER LINES

(71) Applicant: Ralph Dudley Stinson, Lutz, FL (US)

(72) Inventor: Ralph Dudley Stinson, Lutz, FL (US)

(21) Appl. No.: 13/565,203

(22) Filed: Aug. 2, 2012

Related U.S. Application Data
(60) Provisional application No. 61/515,093, filed on Aug. 4, 2011.

(51) Int. Cl. B25J 1/04

(52) U.S. Cl. 294/175

(57) ABSTRACT

A tool for the removal of vines and vegetation from a power line is provided. The tool includes a shank, a base connected to a first end of the shank, and at least one prong extending outwardly from a second end of the shank for removing the vines and vegetation from the power line. The shank is adapted to attach to an insulated hand tool.

### BACKGROUND OF THE INVENTION

This application claims the benefit of Provisional Application No. 61/515,093 filed on Aug. 4, 2011.

The present invention relates generally to tools used by utility workers on “hot” power lines, and more particularly to a tool for the removal of vines and other vegetation from the hot power lines.

Vines and other vegetation disposed along power lines can cause serious power outages and service interruptions and, as a result, need to be removed from those power lines. Vegetation can also create dangerous situations for utility workers conducting repairs by creating tripping hazards, tangling hazards, and loss of balance due to the utility worker trying to move the vegetation from the work area. Further, the above hazards could result in the utility worker coming into contact with a hot power line.

Currently, there are no tools or attachments designed to remove vines or vegetation from hot power lines. Consequently, utility workers are left to their own devices which often times results in some sort of in the field, homemade tool being used or the incorrect use of other available tools that are not designed for the particular job at hand.

Since there is a preference to work the lines hot, that is, without cutting the electrical power, for a period of time, there is a need for a tool or attachment that allows a utility worker to remove vegetation from the hot power lines from the ground or from a pulpit lift without putting the utility worker in danger.

### BRIEF SUMMARY OF THE INVENTION

These and other shortcomings of the prior art are addressed by the present invention, which provides a tool adapted to be used with universal insulated hand tools such as “hotsticks” to remove vines and vegetation from hot power lines.

According to an aspect of the invention, a tool for the removal of vines and vegetation from a power line includes a shank, a base connected to a first end of the shank, and at least one prong extending outwardly from a second end of the shank for removing the vines and vegetation from a power line. The shank is adapted to attach to an insulated hand tool.

According to another aspect of the invention, a tool for the removal of vines and vegetation from a power line includes a shank, a base connected to a first end of the shank for attaching the tool to an insulated hand tool, and a plurality of prongs extending outwardly from a second end of the shank for removing the vines and vegetation from a power line. The base includes a receiver adapted to receive a portion of the shank and provide a solid connection between the shank and the base and a head adapted to mate with and secure the tool to the insulated hand tool.

### BRIEF DESCRIPTION OF THE DRAWINGS

The subject matter that is regarded as the invention may be best understood by reference to the following description taken in conjunction with the accompanying drawing figures in which:

FIG. 1 is a perspective view of a tool according to an embodiment of the invention;

FIG. 2 is a front elevation view of the tool of FIG. 1;

FIG. 3 is a rear elevation view of the tool of FIG. 1;

FIGS. 4 and 5 are side elevation views of the tool of FIG. 1;

FIG. 6 is a top view of the tool of FIGS. 1; and

FIG. 7 is a bottom view of the tool of FIG. 1.

### DETAILED DESCRIPTION OF THE INVENTION

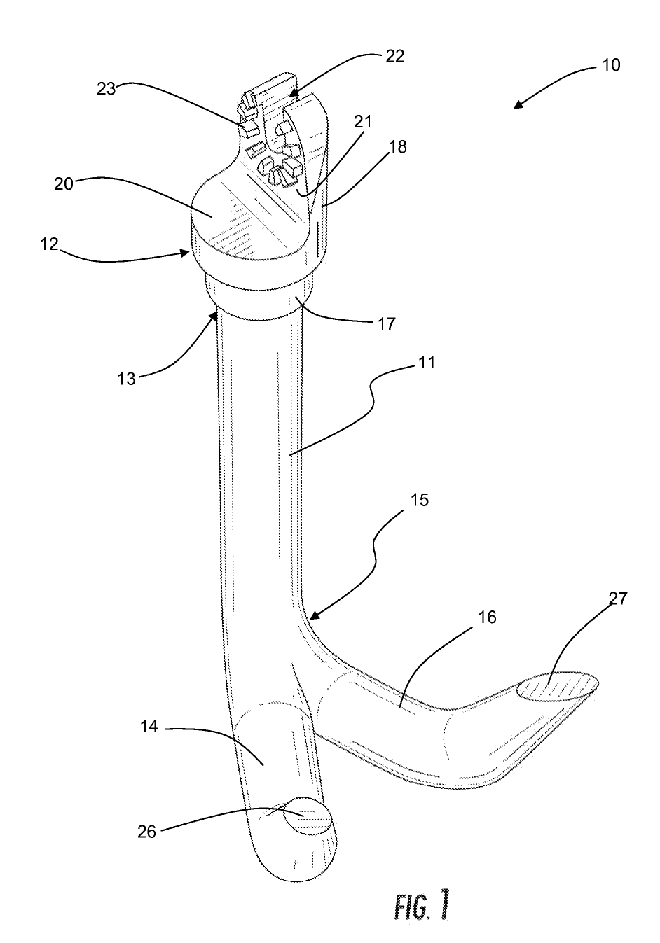

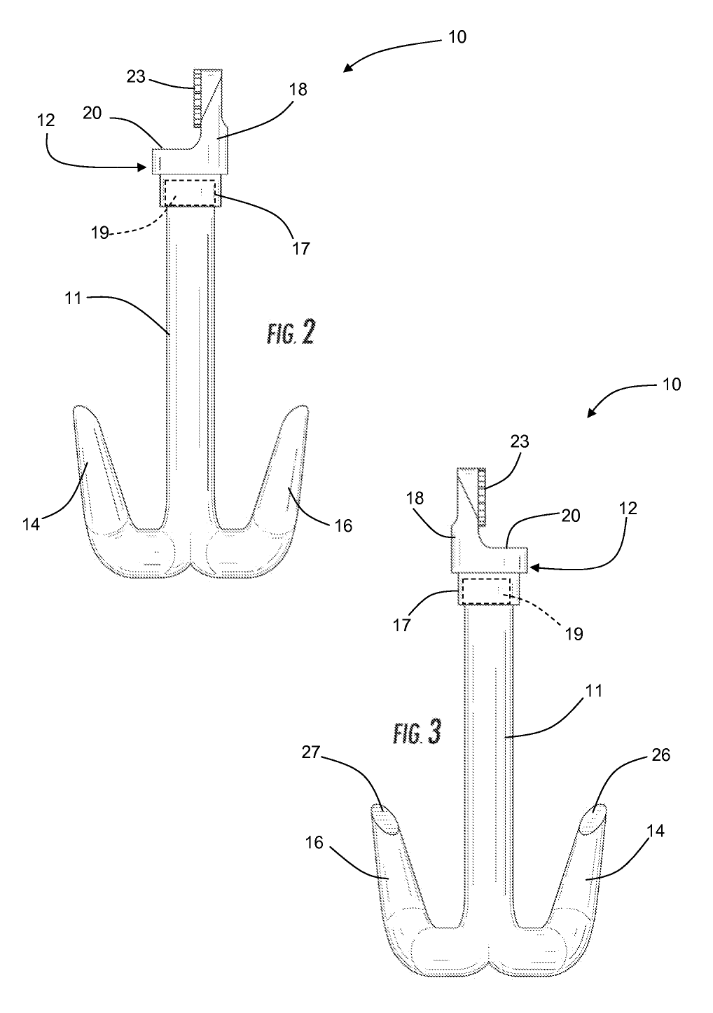

Referring to the drawings, an exemplary tool according to the present invention is illustrated in FIGS. 1-7 and shown generally at reference numeral 10. The tool 10 is in the form of a hook and includes a shank 11, a base 12 connected to a first end 13 of the shank for attachment to an insulated hand tool such as a “hotstick”, and a pair of prongs 14 and 16 extending outwardly from a second end 15 of the shank 11. It should be appreciated that other combinations of prongs may be used. For example, the tool 10 could have a single prong or three prongs extending outwardly from the shank 11.

As shown, the shank 11 and prongs 14 and 16 are made of a fiberglass reinforced nylon to provide a light weight, non-conductive material. This provides protection from electrical shock and prevents fatigue for the utility worker. The base 12 is made of aluminum to provide corrosion resistance and a strong secure attachment to an insulated hand tool. It should be appreciated that other suitable materials may be also be used.

The base 12 includes a receiver 17 and a head 18. The receiver 17 includes a bore 19 therein adapted to receive a portion of the shank 11 to provide a solid connection between the shank 11 and the base 12. The head 18 is substantially L-shaped to provide support and connecting surfaces 20 and 21 which are adapted to mate and secure the tool 10 to a head of an insulated hand tool. As shown, surface 20 is disposed perpendicular to surface 21. The support surface 20 is adapted to rest against a top of an insulated hand tool connected to the tool 10 and regardless of the angle of inclination of the tool 10 relative to the insulated hand tool it is connected to.

The connecting surface 21 is adapted to mate with and secure the tool 10 to an insulated hand tool and includes a slot 22 for receiving a fastener or pin and a castellated holding means 23 for engaging or mating with an adjacent castellated holding means disposed on the insulated hand tool to which it is connected. The castellated holding means 23 prevents the tool 10 from rotating with respect to the insulated hand tool when in a secured position and allows the tool 10 to be secured at multiple angles relative to the insulated hand tool as desired.

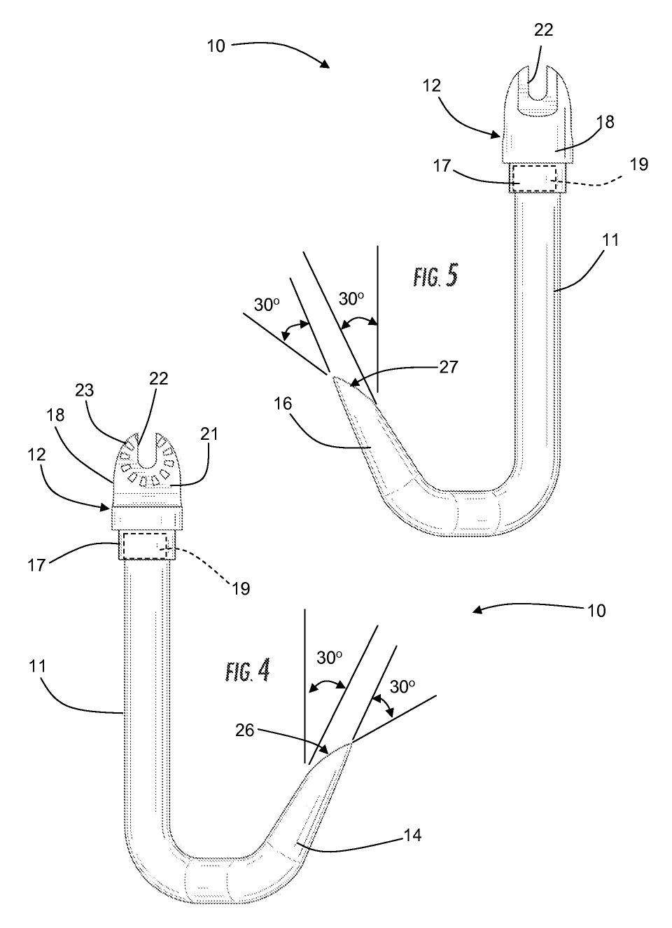

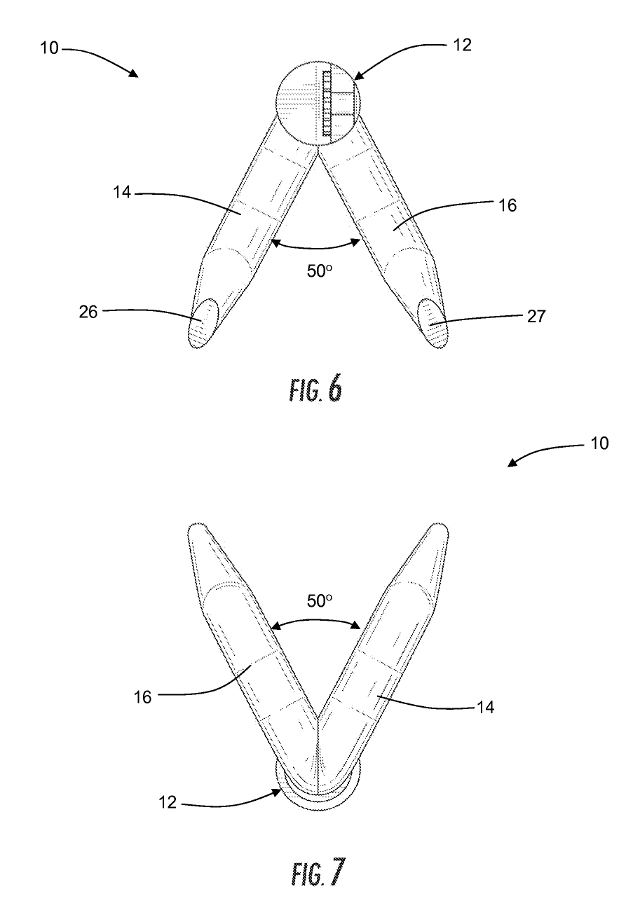

The prongs 14 and 16 are designed to provide efficient removal of vines and vegetation from the power lines. As shown in FIGS. 4 and 5, the prongs 14 and 16 and shank 11 together form a hook. As illustrated, the prongs 14 and 16 extend at an angle relative to the shank of about thirty degrees)(30°. It should be appreciated that other suitable angles may be employed; however, it has been found that a suitable range would be between ten degrees)(10° and seventy degrees) (70°. In addition, the prongs 14 and 16 emerge from the single shank and form two spaced apart prongs. As illustrated in FIGS. 6 and 7, the prongs 14 and 16 form a fifty degree)(50° angle relative to each other. It should be appreciated that other suitable angles may be used; however, it has been found that a suitable range would be between thirty degrees)(30° and one-hundred and ten degrees)(110°.

The prongs 14 and 16 also include angled tips 26 and 27 to allow the prongs to slide between the vines or vegetation and a power line. As illustrated, FIGS. 4 and 5, the tips 26 and 27 are formed at an angle relative to the prongs of thirty degrees)(30° with a suitable range of ten degrees)(10° to fifty degrees)(50°.

The foregoing has described a tool for the removal of vines and vegetation from a hot power line. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

I claim:

1. A tool for the removal of vines and vegetation from a power line, comprising:
(a) a shank;
(b) a base connected to a first end of the shank, the shank being adapted for attachment to an insulated hand tool; and
(c) at least one prong extending outwardly from a second end of the shank for removing the vines and vegetation from a power line.

2. The tool according to claim 1, wherein the shank and at least one prong are formed of a fiberglass reinforced nylon to provide a light weight, non-conductive material.

3. The tool according to claim 1, wherein the base is made of aluminum to provide corrosion resistance and a strong secure attachment to the insulated hand tool.

4. The tool according to claim 1, wherein the base includes a receiver having a bore therein adapted to receive a portion of the shank and provide a solid connection between the shank and the base.

5. The tool according to claim 1, wherein the base includes a head adapted to mate with and secure the tool to the insulated hand tool.

6. The tool according to claim 5, wherein the head includes:
(a) a support surface adapted to rest against a top of the insulated hand tool; and
(b) a connecting surface disposed perpendicular to the support surface, the connecting surface being adapted to mate with and secure the tool to the insulated hand tool and includes:
(i) a slot for receiving a fastener or pin therethrough; and
(ii) a castellated holding means for engaging or mating with an adjacent castellated holding means disposed on the insulated hand tool.

7. The tool according to claim 6, wherein the castellated holding means prevents the tool from rotating with respect to the insulated hand tool.

8. The tool according to claim 1, wherein the at least one prong extends outwardly at an angle relative to the shank of about thirty degrees)(30°.

9. The tool according to claim 1, wherein the at least one prong extends outwardly from the shank at an angle between about ten degrees)(10° and about seventy degrees)(70°.

10. The tool according to claim 1, wherein the at least one prong includes an angled tip adapted to allow the at least one prong to slide between the vines or vegetation and power line.

11. A tool for the removal of vines and vegetation from a power line, comprising:
(a) a shank;
(b) a base connected to a first end of the shank for attaching the tool to an insulated hand tool, the base including:
(i) a receiver adapted to receive a portion of the shank and provide a solid connection between the shank and the base; and
(ii) a head adapted to mate with and secure the tool to the insulated hand tool; and
(c) a plurality of prongs extending outwardly from a second end of the shank for removing the vines and vegetation from a power line.

12. The tool according to claim 11, wherein the plurality of prongs emerge from the shank and form two spaced apart prongs spaced at an angle of about fifty degrees)(50° relative to each other.

13. The tool according to claim 11, wherein the plurality of prongs emerge from the shank and form two spaced apart prongs spaced at an angle between about thirty degrees)(30° and about one-hundred and ten degrees)(110°.

14. The tool according to claim 11, wherein the plurality of prongs each include an angled tip adapted to permit each prong to slide between the vines or vegetation and a power line.

15. The tool according to claim 14, wherein the angled tip of each prong is formed at an angle relative to each prong of about thirty degrees)(30°.

16. The tool according to claim 14, wherein the angled tip of each prong is formed at an angle between about ten degrees)(10° to about fifty degrees)(50°.

17. The tool according to claim 11, wherein the head includes:
(a) a support surface adapted to rest against a top of the insulated hand tool; and
(b) a connecting surface disposed perpendicular to the support surface, the connecting surface being adapted to mate with and secure the tool to the insulated hand tool and includes:
(i) a slot for receiving a fastener or pin therethrough; and
(ii) a castellated holding means for engaging or mating with an adjacent castellated holding means disposed on the insulated hand tool, wherein the castellated holding means prevents the tool from rotating relative to the insulated hand tool and allows the tool to be secured at multiple angles relative to the insulated hand tool.
